(19) United States
(12) Patent Application Publication
(10) Pub. No.: US 2007/0200074 A1
(43) Pub. Date: Aug. 30, 2007

(54) Long life self-luminous microspheres

(76) Inventor: Michael P. Kohnen, Clayton, WI (US)

Correspondence Address: Tipton L. Randall, 19371 55th Avenue, Chippewa Falls, WI, 54729, US

(21) Appl. No.: 11/710,345

(22) Filed: Feb. 23, 2007

Related U.S. Application Data
(60) Provisional application No. 60/776,249, filed on Feb. 24, 2006.

(51) Int. Cl. F21K 2/00; B32B 9/00; B32B 1/00

(52) U.S. Cl. 250/462.1; 428/690; 428/402; 40/542

(57) ABSTRACT

This invention relates to a means for more efficiently and more safely providing self-luminous lighting devices for use in signs, markers, indicators and the like. The present invention provides self luminosity by means of a plurality of glass or polymer microspheres containing both a light-emitting phosphor and a radioactive gas. The “soft” emission of electrons from the beta emitting gas cannot penetrate the glass or polymer wall of the microspheres, thereby constituting no radiation hazard. A further advantage of the present invention is that the plurality of individual containment microspheres minimizes the escape of radioactive gas in the event of any physical damage to an assembly of such microspheres. A still further advantage of the invention is that the radioactive gas completely surrounds the phosphor particles, thus causing light emission from one hundred percent of the surface of the particles.

### CROSS-REFERENCE TO RELATED APPLICATIONS, IF ANY

This application claims the benefit under 35 U.S.C. §119 (e) of co-pending provisional application Ser. No. 60/776,249, filed 24 Feb. 2006. Application Ser. No. 60/776,249 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates to a long life illumination source and, more particularly, to a self-contained, long life illumination source and, most particularly, to long life, self-luminous microspheres for such use.

2. Background Information

Self-luminous signs and indicators have been in use since early in the twentieth century and have experienced numerous improvements over the intervening years. The early uses of self-luminosity employed radium as the activator for a phosphor; however, radium constituted a health hazard from its “hard” radiation and was abandoned. In more recent times a number of radio isotopes have been developed and produced, which serve to activate phosphors to luminescence. Depending upon the choice of isotope, one may obtain alpha, beta or gamma radiation and it has been found that alpha and gamma radiation are hazardous to health, leaving the beta radiators as the safe type for self-luminescence devices. By definition, the beta radiators emit electrons which are relatively heavy particles and exhibit less velocity. This type of radiation will not penetrate a thin glass wall, such as is employed in the present invention. However, beta radiation is effective in causing phosphors to luminesce. Among the beta radiating isotopes, we have selected tritium as the activator for the present device. Tritium exhibits a half-life of 12.5 years, which is quite adequate for the purpose intended. Other isotopes might be used; however, some have small amounts of “hard” radiation and exhibit differing half-lives, such as:

Promethium¹⁴⁷, having a half-life of 2.7 years, Thallium²⁰⁴, having a half-life of 3.6 years and Krypton⁸⁵, having a half-life of 10.0 years. However, Krypton⁸⁵ yields approximately 0.5% of its radiation in the form of gamma rays, which are hazardous to living organisms.

Others have made various forms of self-luminous devices; however, these have suffered from lack of efficiency for any of the following causes:

(a) Light being obstructed by the phosphor and the radioactive substance being chemically combined to become a solid.

(b) Light being obstructed or attenuated by having to pass through a layer of phosphor to become visible.

(c) Light being limited by only one side of the phosphor particles being exposed to the radiation.

A further problem with some of the previous devices has been that the phosphor was combined with a binder to allow a film coating on the inside of a glass envelope which contained the radioactive gas. In this instance, not only did the film attenuate the light, but the binder deteriorated with time due to its exposure to the radiation.

Some individuals have made self-luminous paints, wherein the radioactive gas was converted to a solid by chemical combination with a transparent polymer, which was then deposited on phosphor crystals. In this instance, exposure to its own radiation resulted in the tritiated polymer losing gas and the tritiated gas compounds readily diffuse through the polymer, thus resulting in a radiation hazard, as well as to degrade the transparency of the polymer.

Work in the area of self-luminous signs has been done by such companies as American Atomics, Inc., Self Powered Lighting, Inc. and by the Oak Ridge National Laboratories (ORNL). See U.S. Pat. No. 4,383,382 of Self Powered Lighting, Inc. In addition, the 3M company has done considerable work with self-lumination; however, their means involve the hazard and light attenuation problems described above.

NASA's Jet Propulsion Laboratory has done work with the confinement of atomic waste materials in glass envelopes and in a manner similar to that described herein. However, NASA's Jet Propulsion Laboratory employed a standard method of forming glass spheres, and they were not concerned with self-luminescence. No phosphors were involved with their work.

A recent invention, disclosed in U.S. Pat. No. 4,677,008 by Webb, provides a safe and efficient self-luminous microspheres and a process for making the same. The self-luminous microspheres disclosed are of limited utility because the phosphor particles were inefficient at producing illumination from the tritium radiation and are subject to degradation, particularly on exposure to ultraviolet light. The ultraviolet light degradation of the phosphor particles, disclosed by Webb, prevents applications in which the self-luminous microspheres are located outdoors.

Applicant has devised an improved and more efficient self-luminous microspheres that overcome many of the shortcomings of those disclosed in the above-mentioned patents.

### SUMMARY OF THE INVENTION

The invention obviates the problems described in the foregoing approaches to self-luminosity by confining the radioactive material within a glass walled sphere, along with the light-emitting phosphor in such manner that the emitted light does not have to pass through any light attenuating medium.

Though numerous radioactive gases might be employed, tritium gas was chosen as the activator for the light-emitting phosphor. Tritium is a “soft” beta emitter, and the radiation does not penetrate the glass wall of the envelope. The clear borosilicate glass microsphere offers no appreciable attenuation of the emitted light.

The formation of glass microspheres is a well-known art and is widely used in providing strong, light-weight fillers for epoxies and the like. Also well known is the art of filling such microspheres with a gas, since the gas pressure is fundamental to the formation of the hollow spheres.

The present invention employs light-emitting phosphor particles that embody high efficiency in converting tritium radiation into visible light. The phosphor particles also are highly resistant to degradation by ultraviolet light, thus enabling applications where the microspheres are exposed to sunlight.

The phosphor particles, according to the preferred embodiment of the invention, have the general formula: MO.(n−x){aAl₂O₃^{α}+(1−a)Al₂O₃^{γ}}.xB₂O₃: R, where M is any alkaline earth metal preferably selected from among Sr, Ca and Ba, and R is a rare earth element selected from La, Ce, Pr, Nd, Sm, Gd, Tb, Dy, Ho, Er, Tm, Yb, Lu, Mn and Bi. Most preferably, the phosphor particles of the present invention contain strontium aluminate borate.

### BRIEF DESCRIPTION OF THE DRAWINGS

FIG. 1 illustrates an apparatus used in the process of forming the gas filled microspheres of the present invention.

FIG. 2 shows an envelope containing phosphor particles and radioactive gas in full section.

FIG. 3 illustrates an alternative apparatus used in the process of forming the gas filled microspheres of the present invention.

FIG. 4 shows a detailed view of the outlet of the apparatus of FIG. 3 where the gas filled microspheres are formed.

### DESCRIPTION OF THE EMBODIMENTS

### Nomenclature

1 Crucible

2 Molten Glass or Polymer

3 Gas Inlet

4 Tritium Gas

5 Feed Chamber for Phosphor Particles

6 Capillary Tube

8 Outlet of Funnel

9 Phosphor Particles

10 Funnel

11 First Tube

12 Second Tube

13 Venturi Section

14 Chamber

15 Phosphor Particles and Tritium Gas Mixture

16 Beta Particle Radiation

100 Microsphere Production System

101 Gas Filled Microsphere

102 Container for Tritium

104 Tritium Gas

106 Outlet Valve

108 Transfer Conduit

109 Phosphor Particles

110 Capillary Tube

111 Outlet End of Capillary Tube

112 Inlet Line

114 Reservoir Container for Phosphor Particles

120 Heated Container

122 Molten Glass or Polymer

124 Outlet Nozzle Section

126 Central Bore of Nozzle Section

128 Bottom End of Central Bore

130 Cooling Gas Atmosphere

132 Collection Chamber

134 Outlet Conduit of Collection Chamber

140 Tritium Recycle Containers

### Construction

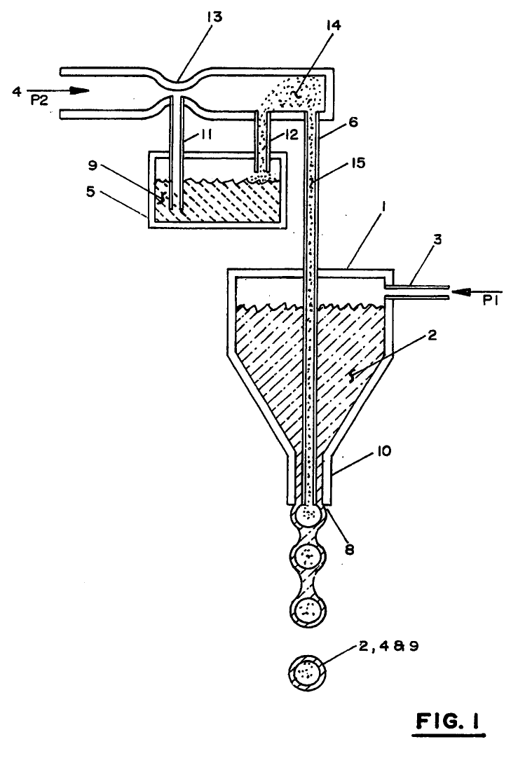

In the present invention, the standard method of forming gas filled microspheres is modified to employ tritium gas and to employ the pressure of the gas to insert the light-emitting phosphor particles into each microsphere. The process for this insertion is best illustrated by referring to FIG. 1, where a crucible 1 containing molten glass or polymer 2 is necked down to form a funnel 10 at its bottom. Concentric within the funnel 10, and of a smaller diameter, is a capillary tube 6 extending upward from the plane of the end of the funnel 10 to a chamber 14. A gas inlet 3 conducts a gas at a suitable pressure (P1) to regulate the flow of molten glass or polymer through the annular area 8 between the funnel 10 and the capillary tube 6. The tritium gas 4 is fed under pressure (P2) to a venturi section 13, where a first tube 11 feeds a relatively high pressure to a chamber 5 containing particles of phosphor 9.

A second tube 12 is located beyond the venturi section 13 at a relatively low pressure area and extends downward into the upper portion of chamber 5 which contains the stock of phosphor particles 9. The pressure differential between the two tubes 11 and 12 results in a relative vacuum in the chamber 14, causing the phosphor particles 9 to rise into the chamber 14 where the flow of the tritium gas 4 sweeps them into the capillary tube 6, forming a mixture of phosphor particles and tritium gas 15, which forms the filler for the gas microspheres being formed at 8. The completed, filled microsphere 4, 2, 9 are shown as they separate from the annular area at the bottom of the equipment. FIG. 1 is schematic only and does not represent the actual proportions of the components of the system. The pressure of the tritium gas 4 may be pulsed to aid in forming the microspheres. The microsphere 2 must be fabricated from a material transparent to visible light, such as glass or polymer, in order for the light emitted by the phosphor particles 9 to traverse the gas tight microsphere envelope 2 containing the tritium gas 4 and phosphor particles 9.

The phosphor particles 9, according to the preferred embodiment of the invention, have the general formula: MO.(n−x){aAl₂O₃^{α}+(1−a)Al₂O₃^{γ}}.xB₂O₃: R, where M is any alkaline earth metal preferably selected from among Sr, Ca and Ba, and R is a rare earth element selected from La, Ce, Pr, Nd, Sm, Gd, Tb, Dy, Ho, Er, Tm, Yb, Lu, Mn and Bi. These phosphor particles are available from Qinglong Hao, 45 Yili, Zhujiafedn, Fengtai District, Beijing 100074, China. The preparation of this class of phosphor particles 9 is disclosed in U.S. Pat. No. 5,885,488, and the contents of this reference is incorporated herein. Most preferably, the phosphor particles 9 of the present invention contain strontium aluminate borate.

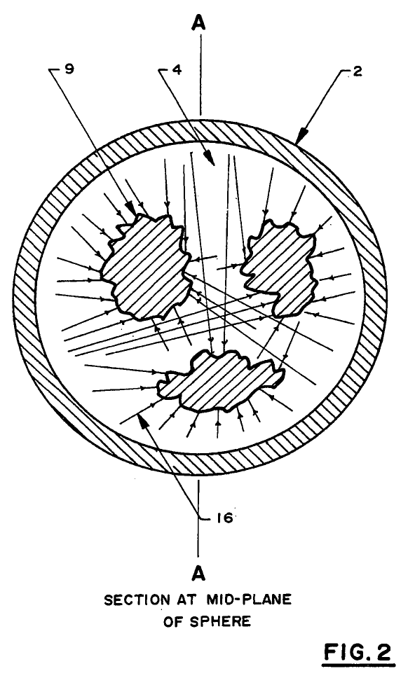

Referring to FIG. 2, it will be noted that the radioactive gas 4 surrounds the phosphor particles 9 within the glass or polymer envelope 2, thus exposing the light-emitting phosphor 9 to radiation 16 from all sides, thus increasing the efficiency of light generation. FIG. 2 shows the phosphor particles 9 in a somewhat ideal dispersal. However, even when more closely packed, the 100% exposure of the phosphor particles 9 to the radiation 16 remains valid.

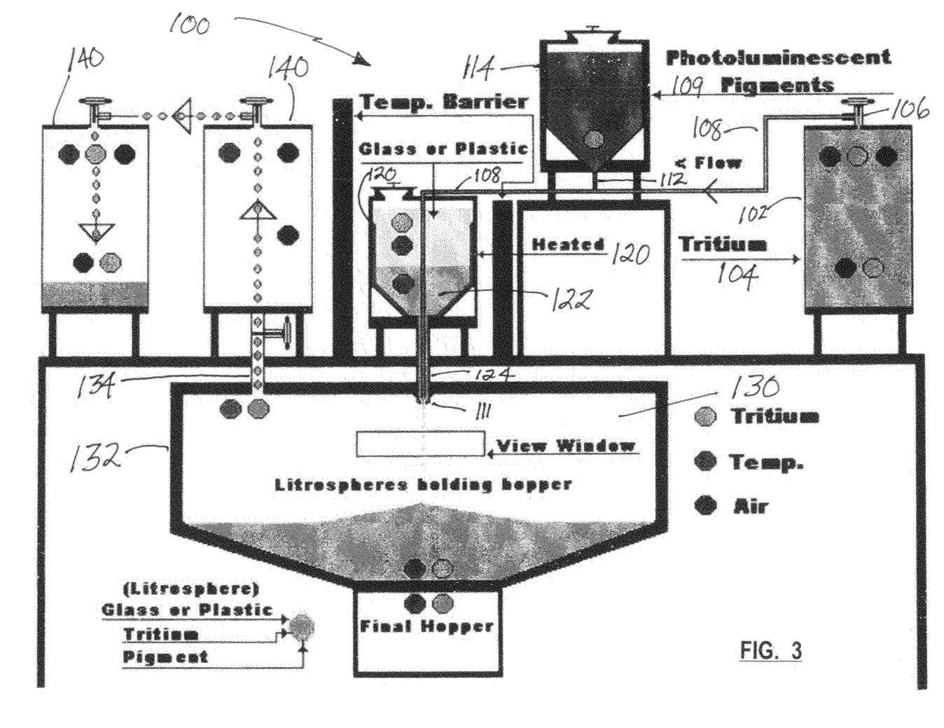

Referring now to FIG.3, an alternative microsphere production system 100, used in the process of forming the gas filled microspheres 101 of the present invention, is illustrated. The production system 100 includes tritium gas 104 confined within a container 102, having an outlet valve 106 connected to a transfer conduit 108 for routing the tritium gas 104 to a capillary tube 110, that passes through a heated container 120. The outlet valve 106 serves to regulate the flow of phosphor particles 109 through the capillary tube 110. The transfer conduit 108 includes an inlet line 112 supplied with phosphor particles 109 from a reservoir container 114. As the phosphor particles 109 enter the transfer conduit 108, the tritium gas 104 carries phosphor particles 109 through the transfer conduit 108 and into the capillary tube 110.

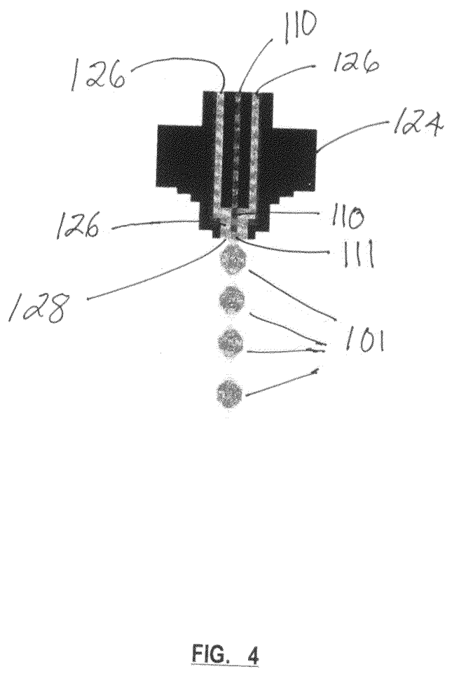

A reservoir of molten glass or polymer 122 is maintained within the heated container 120. The heated container 120 includes an outlet nozzle section 124, illustrated in detail in FIG. 4. The outlet nozzle section 124 includes a central bore 126, with the capillary tube 110 concentrically positioned within the central bore 126. The outlet end 111 of the capillary tube 110 is positioned at the bottom end 128 of the central bore 126 of the outlet nozzle section 124. As small bubbles of the mixture of tritium gas 104 and phosphor particles 109 emerge from the outlet end 111 of the capillary tube 110, the molten glass or polymer 122 forms a gas tight envelope or microsphere 101 to encapsulate the mixture. The resulting microspheres 101 fall through a cooling gas atmosphere 130 contained within a collection container 132 and collect at the bottom of the collection container 132. Any microspheres 101 that do not seal properly results in tritium gas 104 contaminating the cooling gas atmosphere 130 within the collection chamber 132. The resulting cooling gas atmosphere 130 is routed through an outlet conduit 134 and through several tritium recycle containers 140, where the tritium 104 is collected for recycling to the head of the microsphere production system 100. Preferably, the polymer 122 selected for the gas tight envelope or microsphere 101 is resistant to degradation by beta radiation from the tritium gas 104 contained therein.

A plurality of the microspheres 101 of FIG. 2 may be disposed on a surface to form signs, markers, indicators and the like, useful for outdoor applications. A plurality of the microspheres 101 of FIG. 2 may be disposed in a transparent binder to form a luminous paint, also useful for outdoor applications. As mentioned above, the phosphor particles 9 or 109 of the present invention are highly resistant to degradation by ultraviolet light, thus enabling applications where the microspheres 101 are exposed to sunlight.

The microspheres 101 of the present invention provide many advantages in comparison to prior known self-luminous devices. The continuous excitation of the phosphor particles 9 or 109 by the radioactive decay of tritium gas 4 or 104 provides visible light continuously for the life of the microsphere 101. The extended production of usable light, without the need for additional energy to recharge the phosphor particles 9 or 109, results in an extremely, economical light source. The exceptional stability of the phosphor particles 9 or 109 to ultraviolet light degradation allows continuous usage of the microspheres 101 in any location, indoors or out, as well as under water.

Additionally, the exceptional features of the microspheres 101 of the present invention allow a device containing the microspheres 101 to replace conventional lighting devices requiring a source of electrical energy. Consequently, with wide spread usage of the present invention, electrical power usage can be greatly reduced. This, in turn, results in decreased green house emissions from power plant combustion of fossil fuels, thereby assisting in combating global warming.

While the invention has been particularly shown and described with reference to preferred embodiments thereof, it will be understood by those skilled in the art that various changes in form and details may be made therein without departing from the spirit and scope of the invention.

What is claimed is:

1. A self-luminous microsphere comprising:
(a) a gas tight, visible light transparent, envelope;
(b) a radioactive gas confined within the envelope; and
(c) at least one phosphor particle disposed within the envelope and responsive to the radiation from the gas to become luminous, characterized by said particle being loose within the envelope to thereby receive radiation on all sides, the particle comprising strontium aluminate borate and being resistant to ultraviolet degradation, thereby rendering the self-luminous microsphere useful for outdoor applications.

2. A self-luminous microsphere as set forth in claim 1, wherein the gas is tritium.

3. A self-luminous microsphere as set forth in claim 1, wherein the gas confined within the envelope is at a pressure greater than atmospheric pressure.

4. A self-luminous microsphere as set forth in claim 1, wherein the visible light transparent envelope is selected from the group consisting of glass and polymer.

5. A plurality of microspheres as set forth in claim 1, disposed on a flat surface to act as a sign useful for outdoor applications.

6. A plurality of microspheres as set forth in claim 1, disposed in a transparent binder to form a luminous paint useful for outdoor applications.

7. A self-luminous microsphere comprising:
(a) a gas tight, visible light transparent, envelope;
(b) tritium gas confined within the envelope; and
(c) at least one phosphor particle disposed within the envelope and free to move within the envelope, and responsive to radiation from the radioactive tritium gas to become luminous, the particle comprising strontium aluminate borate and being resistant to ultraviolet degradation, thereby rendering the self-luminous microsphere useful for outdoor applications.

8. A self-luminous microsphere of claim 7, wherein the gas tight, visible light transparent, envelope is fabricated from borosilicate glass.

9. A self-luminous microsphere of claim 7, wherein the gas tight, visible light transparent, envelope is fabricated from a polymer resistant to radiation from the tritium gas.
